(19) United States
(12) Patent Application Publication
(10) Pub. No.: US 2011/0117803 A1
(43) Pub. Date: May 19, 2011

(54) CONSTRUCTION BOARD

(76) Inventor: Zvi Barzilai, Moshav Haniel (IL)

(21) Appl. No.: 13/004,041

(22) Filed: Jan. 11, 2011

Related U.S. Application Data
(63) Continuation-in-part of application No. 10/595,524, filed on Apr. 26, 2006, now abandoned.

(30) Foreign Application Priority Data
Oct. 30, 2003 (IL) 158675IL

(51) Int. Cl. B28B 19/00; B32B 3/00

(52) U.S. Cl. 442/1; 156/390; 156/303.1

(57) ABSTRACT

A construction board comprising: a substrate; a coating layer on the substrate; and a mesh disposed within the coating layer, wherein the coating layer comprises protrusions whose perimeter is defined by the mesh. An apparatus for and method of producing the board are also disclosed.

### CROSS-REFERENCE TO RELATED PATENT APPLICATIONS

This application claims priority from Israel patent application 158675, entitled “Board for the construction industry”, filed on Oct. 30, 2003.

This application is a continuation in part of prior U.S. application Ser. No. 10/595,524, entitled “Plastic board” filed Apr. 26, 2006, the entire contents of which are incorporated herein.

### FIELD OF THE INVENTION

The present invention relates to construction boards, in particular to coated light building boards.

### BACKGROUND OF THE INVENTION

Plastic boards made of a foamed board with a polymer or other such coatings find many uses in the construction industry. Such boards are used in the bathroom or other areas of high humidity, for example. The boards may be any type of board used in the construction industry, for example, one known as a light building board, made of a foamed polymer such as XPS (extruded polystyrene) or EPB (expanded polystyrene beads).

The boards are coated, often on both sides, with a thin layer of plastic adhesive or mortar-like material. The coating may include a mixture of plastic adhesives, additives and cement/concrete, as known in the art. The coating improves the mechanical strength of the board and its impact-related properties. Thus, the board is light weight and has good thermal insulating properties as well as improved mechanical strength and machinability. The coating may include flame-retardant materials. Preferably, the thin coating is applied over a mesh made of fiberglass or plastic.

A particular issue with such boards is unreliable bonding to other construction materials such as tiles, plaster, etc or construction elements, for example, walls, bathtubs, etc.

An example of such a board is disclosed in US 2004/043,682(Taylor). The board comprises a polystyrene substrate or core layer upon which there is a non-shrinking cement compound having a stretchable woven mesh therein. On the other side of the polystyrene core layer is a mat layer having a mat fabric and a cement compound. Production of the board includes: passing the mesh into a roll coater to coat the mesh on both sides with cement compound; removing excess cement slurry with a doctor blade; and laying the cement-coated mesh on carrier sheets using a drag bar, which helps urge cement slurry into the interstices of the mesh. The carrier sheets are later adhered to the substrate. The resultant cement layer is generally flat, although the cement coating slightly protrudes above where the mesh fibers are located, i.e. the mesh produces linear crisscrossing ridges or protruding lines in the cement coating. The mesh is not located at the perimeter of the protruding lines rather the mesh fiber is directly underneath those lines.

### SUMMARY OF THE INVENTION

The present invention relates to construction boards, in particular to coated light building boards, designed to have improved mechanical strength and/or adherence to other construction materials/elements.

In accordance with one aspect of the present invention there is provided a construction board comprising: a base board or substrate; a coating layer on the substrate; and a mesh disposed within the coating layer. The coating layer comprises protrusions whose perimeter is defined by the mesh; i.e. the protrusions protrude from the voids (open areas) of the mesh and the mesh is disposed adjacent and below depressions in the coating surface—depressions surround each protrusion.

In particular embodiments, the mesh is spaced apart from the substrate. In some embodiments, the protrusions of the coating layer are, or essentially are, dome-shaped, in other embodiments the protrusions have a tapering square shape or a tapering rectangular shape.

Depending upon the spacing of the fibers of the mesh, and perhaps other adherence properties between the mesh material and the coating formulation, the protrusions taper downward from their centers to their edges, which are adjacent the mesh. If the spacing of the mesh fibers is particularly small, the protrusions tend to be dome-shaped, otherwise the protrusions are typically square or rectangular with edges that slope/taper down toward their perimeters, which are adjacent the mesh fibers. These protrusions are in contrast to the generally flat (planar) coating of known coated construction board, and so the board of the present invention provides an improved adherence/bonding to other building elements and materials and tends to be stronger. In that regard, the coating of the board of the present invention tends to be thicker, for example between 1-5 mm, which also improves the board's performance (in particular the board's strength).

According to another aspect of the present invention, there is provided an apparatus for producing a construction board of the type having a substrate and a coating with a mesh therein, the apparatus comprising: a board conveying support surface; a device for placing a coating slurry onto the substrate; a doctor blade disposed above the substrate and downstream of the board conveying support surface; and a mesh application blade downstream of the doctor blade and located above the substrate at a distance closer to the substrate than the doctor blade and at a distance greater than the thickness of the mesh and under which the mesh passes.

In some embodiments the apparatus further comprises a spool from which the mesh is delivered and in other embodiments further comprises a mesh angle delivery bar for controlling the feed of the mesh.

According to yet another aspect of the present invention, there is provided a method of producing a construction board, comprising: applying a coating slurry over a substrate; spreading the coating slurry on the substrate with a doctor blade to form a coating layer on the substrate; and passing a mesh under a mesh application blade, which is lower (closer to the substrate) to the substrate than the thickness of the coating layer (typically meaning that the mesh application blade is closer to the substrate than the doctor blade). The lower-disposed mesh application blade causes a build-up of slurry collecting behind the mesh application blade so that the mesh passes through the built-up coating slurry and the mesh is thus urged into the coating layer by that built up slurry and/or the mesh application blade. However, the mesh application blade is spaced apart from the substrate, and the mesh is of a thickness, whereby in preferred embodiments the mesh does not abut the substrate. Without limitation to theory, the process results in slurry protruding upward/outward from the board at the interstices of the mesh.

### BRIEF DESCRIPTION OF THE DRAWINGS

The present invention will be understood and appreciated more fully from the following detailed description taken in conjunction with the appended drawings in which:

FIGS. 1 and 2 are respective perspective (with partial cut-away) and cross-sectional views of a prior art light building board;

FIG. 3 is a cross-sectional view of an embodiment of a building board of the present invention;

FIG. 4 is a cross-sectional view illustrating an embodiment of an apparatus for manufacturing a construction board in accordance with the present invention; and

FIG. 5 is a top view of a building board produced by the apparatus of FIG. 4.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DESCRIPTION OF EMBODIMENTS OF THE INVENTION

Illustrative embodiments of the invention are described below. In the interest of clarity, not all features/components of an actual implementation are necessarily described.

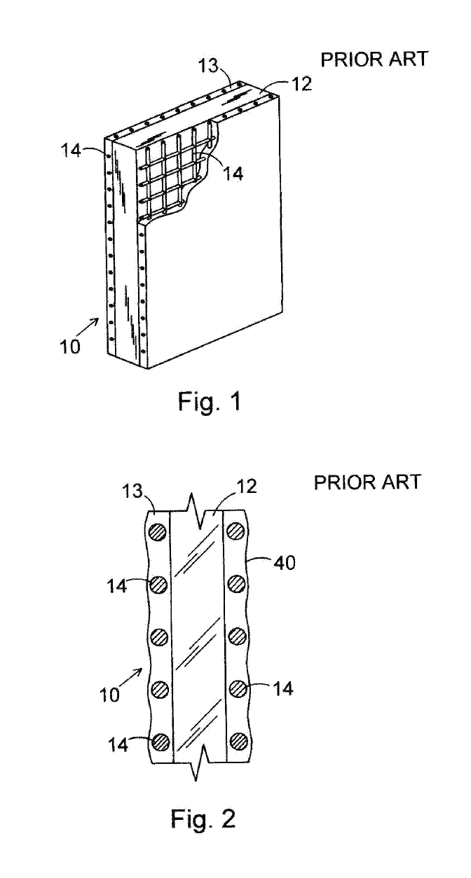

FIG. 1 illustrates the structure of a segment of a prior art light building board 10 comprising a foamed board 12 with two of its sides coated with a thin coating layer 13 of a plastic adhesive or cement. A fiberglass or plastic mesh 14 is embedded in the coating layer 13. Mesh 14 improves the mechanical properties of the board.

FIG. 2 shows a cross-sectional view of a segment of same prior art light building board 10 of FIG. 1. The coating layer 13 is thin and has a generally flat external surface 40. Such a surface makes it more difficult to attach other construction parts to the board 10. Moreover, thin coating layer 13 may not reliably hold the mesh 14 secured to the foamed board 12, thus sometimes allowing the mesh to become separated from the board.

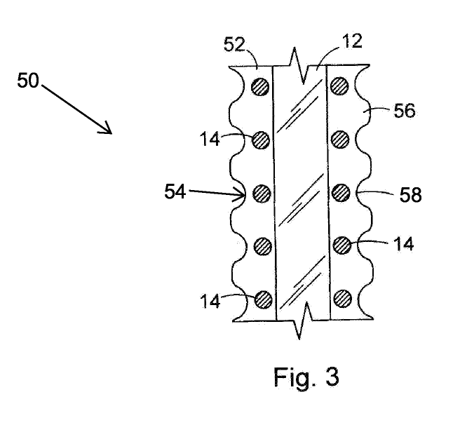

FIG. 3 shows a cross-sectional view of an embodiment of a building board 50 in accordance with the present invention. Board 50 has a coating 52, preferably relatively thick, with an external surface 54 in which protrusions 56 are formed. It can be seen that protrusions 56 extend out of the interstices of mesh 14 and so the mesh can be thought of as defining the perimeter of the protrusions 56, as can be seen in FIG. 3 and FIG. 5. Above mesh 14 are depressions 58 in the coating 52, between (forming boarders between) protrusions 56.

For example, for a board about 2 cm thick, a coating thickness of about 1-5 mm may be used. The materials of the coating may include a mixture of adhesives, cement, and inert material for flow enhancement. Flame retardant materials may be included as well where necessary. The coating is preferably made thicker (e.g. between 1 mm and 5 mm) than in prior art building boards, thus achieving improved performance. The result is a board with an external surface of larger area, which can be reliably bonded to other construction parts.

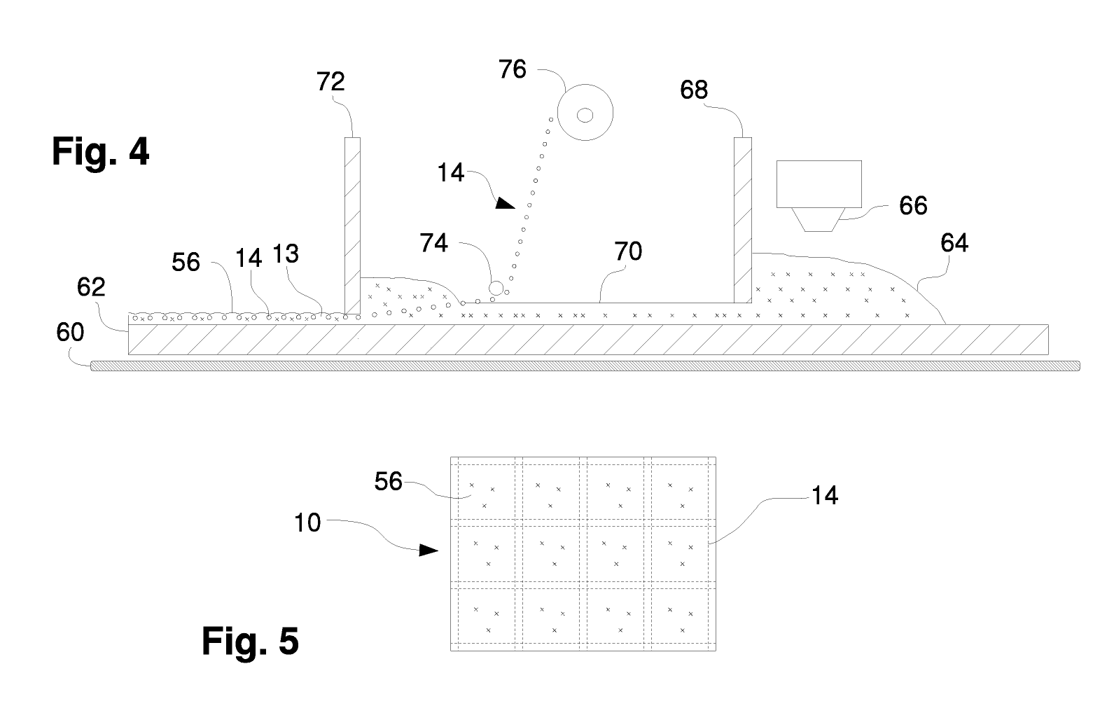

With reference to FIG. 4, there is illustrated a manufacturing apparatus of the present invention for producing a construction board. The apparatus comprises: a board support surface, preferably in the form of a conveyor belt 60 for conveying a substrate 62, for example foamed board 12. A device for placing a coating slurry 64 on substrate 62, for example a delivery tube 66, is located upstream of a doctor blade 68. Doctor blade 68 is disposed above substrate 62 to produce a flatten slurry layer 70 on the substrate. Doctor blade 68 typically has associated therewith a mechanism (not shown) to allow the doctor blade to be moved upward or downward relative to substrate 62 to control the thickness of flattened slurry layer 70.

Downstream of doctor blade 68 is a mesh application blade 72, also located above substrate 62, but disposed somewhat closer to the substrate than doctor blade 68, however at a distance greater than the thickness of mesh 14 so that the mesh application blade does not push the mesh down onto the surface of substrate 62 rather the mesh is surrounded by slurry 64 above and below the mesh. As mesh application blade 72 is at a smaller distance to substrate 62 than doctor blade 68, an amount of slurry 64 tends to be present (a build up or collection of the slurry) behind the mesh application blade.

Mesh 14 is pulled along by any means, for example by attaching a front edge of the mesh to the front of substrate 62, and the mesh is thus fed (pulled) so it passes under mesh application blade 72, for example the mesh may unwind from a spool 74. The height of spool 74 can be controlled else a mesh angle delivery bar 76 can be used to control the entry of mesh 14 into the collection of slurry 64 behind mesh application blade 72. Mesh 14 is urged into flattened slurry layer 70 by the collection of slurry 64 behind mesh application blade 72 and/or the mesh application blade.

The boards can then be cut into smaller boards as desired and the mesh 14 can be trimmed, if and as desired, as coating layer 13 dries. Without limitation to any theory, the apparatus (and method as will be described herein below) can produce boards whose coating layer 13 has a plurality of protrusions 56 due to slurry having protruded upward through the interstices of mesh 14.

Consistent with the above-described apparatus, particular embodiments of a method for producing a building board comprise: applying a coating slurry (e.g. slurry 64) onto a substrate (e.g. substrate 62); spreading the coating slurry on the substrate to form a coating layer on the substrate (e.g. via doctor blade 68); and feeding a mesh into the coating slurry and under a mesh application blade (e.g. mesh application blade 72), the mesh application blade being disposed closer to the substrate than the thickness of the coating slurry (which typically means disposing the mesh application blade closer to the substrate than the doctor blade 68.

The lower-disposed mesh application blade causes a build-up of slurry 64 behind mesh application blade 72 so that mesh 14 passes through the built-up coating slurry and the mesh is thus urged into coating layer 13 by that built up slurry and/or by the mesh application blade. However, mesh application blade 72 is spaced apart from substrate 62, and mesh 14 is of a thickness, whereby in preferred embodiments the mesh does not abut the substrate. Without limitation to theory, the process results in a coating having protrusions extending upward/outward from the board at the interstices of the mesh.

Optionally, the method includes applying one or more additional layers of coating on the substrate at a point in the process after mesh 14 passes under mesh application blade 72.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A construction board comprising:
a substrate;
a coating layer on the substrate; and
a mesh disposed within the coating layer,
wherein the coating layer comprises protrusions whose perimeter is defined by the mesh.

2. The board of claim 1, wherein the mesh is spaced apart from the substrate.

3. The board of claim 1, wherein the protrusions of the coating layer have a tapering square shape.

4. The board of claim 1, wherein the protrusions of the coating layer have a tapering rectangular shape.

5. The board of claim 1, wherein the protrusions of the coating layer are dome-shaped.

6. An apparatus for producing a construction board of the type having a substrate and a coating with a mesh therein, the apparatus comprising:
a board conveying support surface;
a device for placing a coating slurry onto the substrate;
a doctor blade disposed above the substrate and downstream of the board conveying support surface; and
a mesh application blade downstream of the doctor blade and located above the substrate at a distance closer to the substrate than the doctor blade and at a distance greater than the thickness of the mesh and under which the mesh passes.

7. The apparatus of claim 6, further comprising a spool from which the mesh is delivered.

8. The apparatus of claim 6, further comprising a mesh angle delivery bar for controlling the feed of the mesh.

9. A method of producing a construction board, comprising:
(a) applying a coating slurry over a substrate;
(b) spreading the coating slurry on the substrate with a doctor blade to form a coating layer on the substrate; and
(c) passing a mesh under a mesh application blade that is lower to the substrate than the thickness of the coating layer, the mesh also thereby passing through a build-up of coating slurry collected behind the mesh application blade.

10. The method of claim 9, further comprising applying an additional coating onto the substrate after step (c).
